(19) United States
(12) Patent Application Publication
(10) Pub. No.: US 2009/0101289 A1
(43) Pub. Date: Apr. 23, 2009

(54) COMPACTABLE TEMPORARY VEHICLE WINDOW SCREEN WITH PRIVACY PANEL

(76) Inventor: Linda Sheehan, Milwaukee, WI (US)

Correspondence Address: GEHRKE & ASSOCIATES, S.C., 123 N. 86th ST, WAUWATOSA, WI, 53226, US

(21) Appl. No.: 11/859,894

(22) Filed: Sep. 24, 2007

(51) Int. Cl. E06B 9/24

(52) U.S. Cl. 160/89

(57) ABSTRACT

A compactable temporary window screen with privacy panel is for use with any motor vehicle having a doorframe wherein the door window is surrounded by a solid window frame structure. The screen comprises a flexible mesh material shaped in such a way as to allow it to be slipped over the door of a motor vehicle when the door is open and then secured in the proper position by closing the door. An opaque privacy panel is also provided to optionally allow privacy and light control. In one embodiment of the invention the privacy panel may be folded into itself and secured in an attached pouch.

### BACKGROUND OF THE INVENTION

1. Field of Invention

The present invention relates generally to a compactable temporary vehicle window screen with privacy panel for use in motor vehicles.

2. Discussion of Relevant Prior Art

Motor vehicles have window units in their doors that can be lowered to allow the access of outside air into the vehicle. When this window is open, insects and other road debris may undesirably enter the vehicle interior. The use of screening on this open window is desirable to allow the flow of air while preventing insects, debris or the like into the vehicle. While some applications of window screening for vehicle windows can be found, they are difficult to install. The existing screens also are difficult to store when not in use. Furthermore, none provide an easily engagable privacy panel to block light and airflow while the screen is in use.

### BRIEF SUMMARY OF THE INVENTION

A compactable temporary window screen with privacy panel is for use with any motor vehicle having a doorframe wherein the door window is surrounded by a solid window frame structure. The screen comprises a flexible mesh material shaped in such a way as to allow it to be slipped over the door of a motor vehicle when the door is open and then secured in the proper position by closing the door. This allows for easy installation of the window screen. Clips may be provided to aid in securing the screen. An opaque privacy panel is also provided to optionally allow privacy and light control. In one embodiment of the invention the privacy panel may be folded into itself and secured in an attached pouch for easy storage.

### BRIEF DESCRIPTION OF THE DRAWINGS

A clear understanding of the various advantages and features of the present invention, as well as the construction and operation of conventional components and mechanisms associated with the present invention, will become more readily apparent by referring to the exemplary, and therefore non-limiting, embodiments illustrated in the following drawings which accompany and form a part of this patent specification.

FIG. 1 is a side view as seen from the exterior of a vehicle according to the present invention;

FIG. 2 is a side view of the preferred embodiment as seen from the interior of a vehicle with the privacy flap in a closed position.

### DETAILED DESCRIPTION OF THE INVENTION

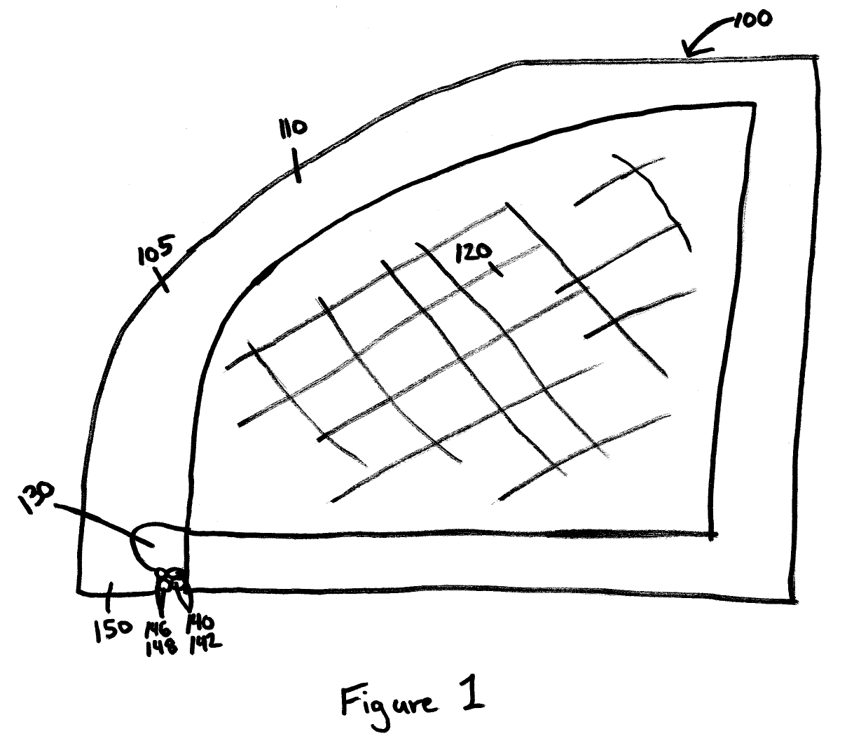

Referring now to FIG. 1, a temporary vehicle window screen with privacy panel (100) has a panel (105) with flexible fabric edging (110). This fabric edging may be made from flexible strong waterproof fabric. The fabric must be strong enough to withstand being repeatedly closed in a vehicle door. Flexible mesh screening or mesh (120) is disposed within the fabric edging (110). Two panels (105) are permanently connected along their fabric edging on all sides except at the bottom. This forms a pocket. The pocket is slipped over a vehicle door. An opening (130) may be provided to accommodate the side-view mirror located on the vehicle. If the opening is provided, elastic (150) may be located near the lower edge of the panel to allow clips (140, 142) and loops (146, 148) to connect and aid in the alignment and securing of the temporary vehicle window screen (100). To employ the temporary vehicle window screen (100), the open bottom side of the screen (100) is placed over the doorframe of a motor vehicle (not shown) while the door is open. The doorframe must be of the type whereby the window is surrounded by a solid window frame structure. The opening (130) is positioned on the vehicles side-view mirror (not shown). Then clips (140, 142) are clipped into loops (146, 148). Closing the vehicle door secures the window screen (100) in place. The window of the door may now be lowered to allow air to flow into and out of the interior of the vehicle.

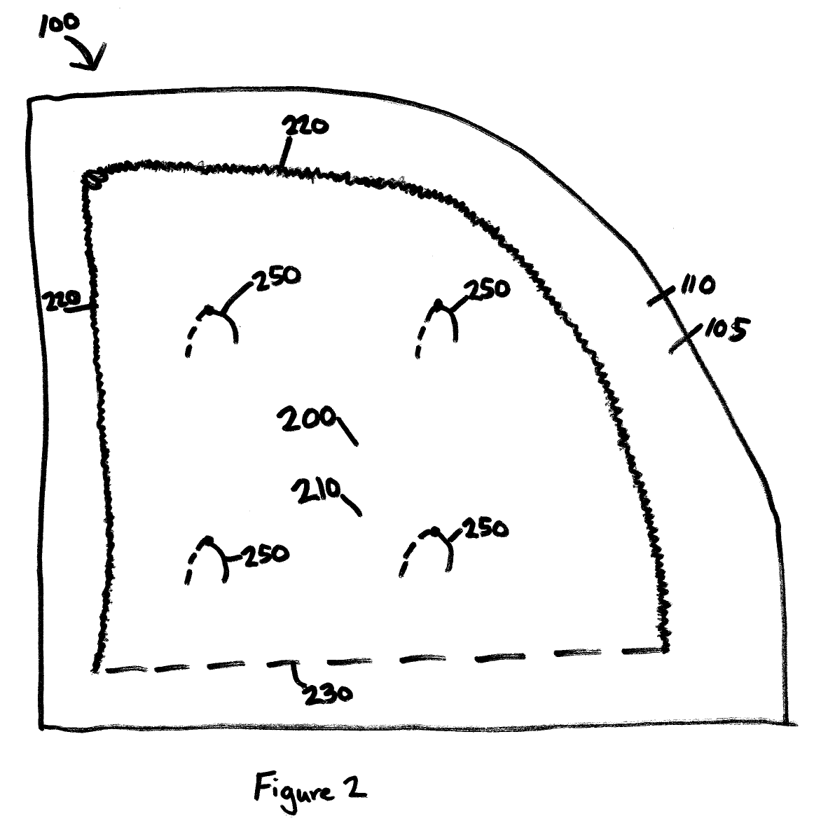

Referring now to FIG. 2, one side of the temporary vehicle window screen (100) is provided with an opaque flap (200). The opaque flap (200) creates a privacy panel (210) when in a “closed” position. The privacy flap is temporarily fastened to the Vehicle window screen (100) by a temporary fastening device such as zippers (220). Other types of similar fastening devices could also be employed. The bottom edge (230) of the opaque flap (200) is permanently secured to the edge material (110) of the window screen (100). When the opaque flap (200) is in the closed position, the airflow through the screen mesh is blocked. Likewise, when the opaque flap (200) is in the closed position, light from outside the vehicle is blocked.

The opaque flap (200) may be place in an open position by unzipping the zipper (220). This would allow for airflow through the screen mesh (120) yet prohibit the entry of insects into the vehicle.

Strings (250) are provided on the privacy flap. When the privacy panel (210) is not in use, it may be rolled and the strings (250) may be tied to keep the opaque flap (200) in a rolled state.

Alternately, when not in use, the window screen (100) may be folded or likewise compacted to allow convenient storage in the vehicle. Further, the window screen (100) can be folded into itself and secured in an attached pouch (not shown).

I/we claim:

1. A vehicle window screen comprising:
A first and second panel wherein one of said first panel has screen fabric and edging material surrounding the screen fabric, said first and second panel form a pocket by connecting their top and side edges, their bottom edges are unconnected forming a pocket opening for insertion of a vehicle door portion; and,
a privacy panel disposed on said second panel, wherein a side of said privacy panel is permanently secured near an edge of said second panel.

2. The vehicle window screen of claim 1 wherein, said screen fabric comprises mesh material.

3. The vehicle window screen of claim 1 further comprising an opening located at a lower edge of said edge material wherein said opening accommodates a side-view mirror of a motor vehicle.

4. The vehicle window screen of claim 1 wherein, said privacy panel is opaque material.

5. The vehicle window screen of claim 1 wherein, said permanently attached side is a bottom side of said privacy panel.

6. The vehicle window screen of claim 1 wherein, said privacy panel further comprised detachment means.

7. The vehicle window screen of claim 6 wherein, said detachment means comprises a zipper.

8. The vehicle window screen of claim 1 further comprising clips and loops, said clips and loops further securing the screen around a side-view vehicle mirror.

9. The vehicle window screen of claim 1 further comprising an attached fabric storage pouch, wherein said window screen may be folded and placed inside said storage pouch.

10. The vehicle window screen of claim 1 further comprising strings, wherein said window screen may be rolled and secured with said strings.

11. A vehicle window screen comprising:
A first and second panel, said first panel having screen fabric and edging material surrounding the screen fabric, said panels form a pocket by connecting their top and side edges, their bottom edges are unconnected forming a pocket opening for insertion of a vehicle door portion; and,
an attached fabric storage pouch, wherein said window screen may be folded and placed inside said storage pouch.

12. The vehicle window screen of claim 11 further comprising a privacy panel on said second panel, said privacy panel permanently secured near an edge along a side of said second panel.

13. The vehicle window screen of claim 11 wherein, said screen fabric comprises mesh material.

14. The vehicle window screen of claim 11 further comprising an opening located at a lower edge of said edge material wherein said opening accommodates a side-view mirror of a motor vehicle.

15. The vehicle window screen of claim 12 wherein, said privacy panel is opaque material.

16. The vehicle window screen of claim 12 wherein, said permanently attached side is a bottom side of said privacy panel.

17. The vehicle window screen of claim 12 wherein, said privacy panel further comprised detachment means.

18. The vehicle window screen of claim 17 wherein, said detachment means comprises a zipper.

19. The vehicle window screen of claim 11 further comprising clips and loops, said clips and loops securing the screen around a side-view vehicle mirror.
